(19) United States
(12) Patent Application Publication
(10) Pub. No.: US 2026/0012025 A1
(43) Pub. Date: Jan. 8, 2026

(54) SERVICEABLE BATTERY DISCONNECT UNIT AND METHOD OF MANUFACTURING AND USING THE SAME

(71) Applicant: GM GLOBAL TECHNOLOGY OPERATIONS LLC, Detroit, MI (US)

(72) Inventors: Robert J. Heydel, Clawson, MI (US); Phillip Daniel Hamelin, Clarkston, MI (US); Alexander M. Bilinski, Avoca, MI (US)

(73) Assignee: GM GLOBAL TECHNOLOGY OPERATIONS LLC, Detroit, MI (US)

(21) Appl. No.: 18/761,428

(22) Filed: Jul. 2, 2024

(51) Int. Cl. H02J 7/00; H01M 10/04; H01M 10/44; H01M 50/249; H01M 50/262; H01M 50/583

(52) U.S. Cl. CPC H02J 7/0031; H01M 10/04; H01M 10/448; H01M 50/249; H01M 50/262; H01M 50/583

(57) ABSTRACT

Disclosed is a battery disconnect unit including a bottom support substrate having at least one fastening feature for removably connecting the battery disconnect unit to a battery pack enclosure. The battery disconnect unit may include at least one of a contactor, a fuse, or a pre-charge circuit carried on top of the bottom support substrate. Disclosed also are methods of assembling the battery disconnect unit to a battery pack enclosure and a method of removing the battery pack disconnect unit from the battery pack enclosure without removing a battery pack and associated components from the battery pack enclosure.

### INTRODUCTION

The technical field generally relates to batteries for an electric vehicle including a serviceable battery disconnect unit and methods of making and using the same.

Electric vehicles include a rechargeable energy storage system and a battery disconnect unit. The battery disconnect unit may have many different designs which typically vary from vehicle to vehicle. A different rechargeable energy storage system connector is typically used for each battery disconnect unit design. Unfortunately, the battery disconnect unit is difficult and costly to service, often requiring most of the battery assembly to be removed in order to service the battery disconnect unit.

Accordingly, it is desirable to provide a simple assembly process and simple service process for the battery disconnect unit. It would also be desirable to provide a battery disconnect that can be serviced without removing a substantial portion of the battery assembly. Furthermore, other desirable features and characteristics of the patentable variations will become apparent from the subsequent detailed description and the appended claims, taken in conjunction with the accompanying drawings and the foregoing introduction.

### SUMMARY

A number of variations may include a product, including: a battery disconnect unit including a bottom support substrate having at least one fastening feature for removably connecting the battery disconnect unit to at least a portion of a battery pack enclosure, the battery disconnect unit including at least one of a contactor, a fuse, or a pre-charge circuit carried on top of the bottom support substrate.

A number of variations may include a product further including at least a portion of a battery pack enclosure, and wherein the battery disconnect unit is removably connected to the at least a portion of the battery pack enclosure.

A number of variations may include a product further including at least one external bracket connected to the at least a portion of the battery pack enclosure, and wherein the battery disconnect unit is removably connected to the at least one external bracket.

A number of variations may include a product further including a first external bracket and a second external bracket each connected to the at least a portion of the battery pack enclosure, wherein the first external bracket and the second external bracket are spaced apart from each other by a distance sufficient to receive at least a portion of the battery disconnect unit therebetween.

A number of variations may include a product wherein the bottom support substrate is removably fastened to the first external bracket and the second external bracket.

A number of variations may include a product wherein the bottom support substrate includes a central portion and a first end and a second end, and wherein at the first end a first side wall extends upwardly from the central portion and a first flange portion extends outwardly from the first side wall, and wherein at the second end a second side wall extends upwardly from the second end and a second flange portion extends outwardly from the second side wall.

A number of variations may include a product further including at least one fastener extending through the first flange portion and into the first external bracket, and at least one fastener extending through the second flange portion and into the second external bracket.

A number of variations may include a product wherein the battery disconnect unit includes a battery disconnect unit high-voltage connector including a seating verification pin.

A number of variations may include a product further including a battery pack enclosure, a connector platform, a battery pack high-voltage connector secured to the connector platform, and wherein the battery pack high-voltage connector is connected to the battery disconnect unit high-voltage connector so that the seating verification pin extends through a through hole formed in the battery pack high-voltage connector so that a proper seating indicator is visible on the seating verification pin.

A number of variations may include a method including: providing an electric vehicle having a battery pack enclosure having therein a rechargeable energy storage system including a plurality of battery cells and a high-voltage bus operatively connected to the plurality of battery cells, a battery disconnect unit removably attached to the battery pack enclosure, the electric vehicle having a bottom, wherein the battery disconnect unit includes at least one battery disconnect unit high-voltage connector connected to the high-voltage bus; disconnecting the at least one battery disconnect unit high-voltage connector from the high-voltage bus supporting the battery disconnect unit and thereafter detaching the battery disconnect unit from the battery pack enclosure; and lowering the battery disconnect unit from the battery pack enclosure so that the battery disconnect unit moves downwardly away from the bottom of the electric vehicle.

A number of variations may include a method, wherein prior to disconnecting the at least one battery disconnect unit high-voltage connector from the high-voltage bus, de-energizing the battery and high voltage bus.

A number of variations may include a method further including repairing or replacing the battery disconnect unit.

A number of variations may include a method further including reinstalling the battery disconnect unit by moving the battery disconnect unit upward towards the bottom of the electric vehicle and removably connecting the battery disconnect unit to the battery pack enclosure.

A number of variations may include a method wherein the battery disconnect unit including a bottom support substrate having at least one fastening feature for removably connecting the battery disconnect unit to a battery pack enclosure, and at least one of a contactor, a fuse, or a pre-charge circuit carried on top of the bottom support substrate.

A number of variations may include a method further including a first external bracket and a spaced apart second external bracket both attached to the battery pack enclosure, wherein at least a portion of the battery disconnect unit is received between the first external bracket and the spaced apart second external bracket, and wherein the bottom support substrate is fastened to each of the first external bracket and the spaced apart second external bracket.

A number of variations may include a method including: providing a battery pack enclosure including at least a bottom cover and a front face connected to the bottom cover; providing a battery disconnect unit having a battery disconnect unit high-voltage connector having a seating verification pin having a portion of which has a color to indicate that the battery disconnect unit high-voltage connector is properly seated; connecting the battery disconnect unit to the front face of the battery pack enclosure; installing battery cells inside the battery pack enclosure; connecting a battery pack high-voltage connector to a battery positive terminal and a negative terminal, the battery pack high-voltage connector having a through hole formed therein for receiving the seating verification pin; and connecting the battery pack high-voltage connector to the battery disconnect unit high-voltage connector so that the seating verification pin extends through the through hole formed in the battery pack high-voltage connector so that the color to indicate that the battery disconnect unit high-voltage connector is properly seated is visible.

A number of variations may include a method further including performing pack level testing.

A number of variations may include a method wherein the battery pack enclosure further includes: a first side face connected to the front face; an opposite second side face each connected to the front face; a rear face connected to the first side face, the rear face connected to a second side face, and wherein the method further includes attaching a top cover to the first side face, second side face, rear face and front face to close the battery pack enclosure.

A number of variations may include a method further including: a first external bracket attached to the front face; and a spaced apart second external bracket attached to the front face, wherein the battery disconnect unit includes a bottom support substrate, and wherein the connecting the battery disconnect unit to the front face of the battery pack enclosure includes connecting the bottom support substrate to the first external bracket and to the spaced apart second external bracket so that the battery disconnect unit is received between the first external bracket and the spaced apart second external bracket.

A number of variations may include a method wherein each of the first external bracket and the spaced apart second external bracket includes a bottom face, and wherein connecting the bottom support substrate to the first external bracket and to the spaced apart second external bracket includes connecting the bottom support substrate to the bottom face of the first external bracket and the bottom face of the spaced apart second external bracket.

### BRIEF DESCRIPTION OF THE DRAWINGS

The illustrative variations will hereinafter be described in conjunction with the following drawing figures, wherein like numerals denote like elements, and wherein:

FIG. 1 is a top, perspective view of a product including a rechargeable energy storage system and a battery disconnect unit according to a number of variations;

FIG. 2 is a schematic illustration of a battery disconnect unit connected to a plurality of battery cell groups according to a number of variations;

FIG. 3 is a partial, top, perspective view of a product including a battery disconnect unit mounted to a battery pack enclosure according to a number of variations;

FIG. 4 is a partial, bottom, perspective view of a product including a battery disconnect unit mounted to a battery pack enclosure according to a number of variations;

FIG. 5 is a partial, top, perspective view with portions broken away of a product including a battery disconnect unit mounted to a battery pack enclosure according to a number of variations;

FIG. 6 is a partial, top, perspective view with portions broken away of a product including a battery disconnect unit mounted to a battery pack enclosure showing a connector seating verification pin according to a number of variations;

FIG. 7 is a partial, top, perspective, exploded view, of a product including a battery disconnect unit mounted to a battery pack enclosure according to a number of variations;

FIG. 8 is a partial, top, perspective view of a product and a method of assembling and removing a battery disconnect unit from a battery pack enclosure according to a number of variations;

FIG. 9 is a flow chart illustrating a method of assembling a battery disconnect unit to a battery pack enclosure according to a number of variations;

FIG. 10 is a flow chart illustrating a method of removing a battery disconnect unit from a battery pack enclosure according to a number of variations; and

FIG. 11 is a schematic illustration of electric vehicle having a battery disconnect unit that may be installed and uninstalled from the bottom of the electric vehicle.

### DETAILED DESCRIPTION

The following detailed description is merely exemplary in nature and is not intended to limit the application and uses. Furthermore, there is no intention to be bound by any expressed or implied theory presented in the preceding introduction, brief description of the drawings, brief summary or the following detailed description.

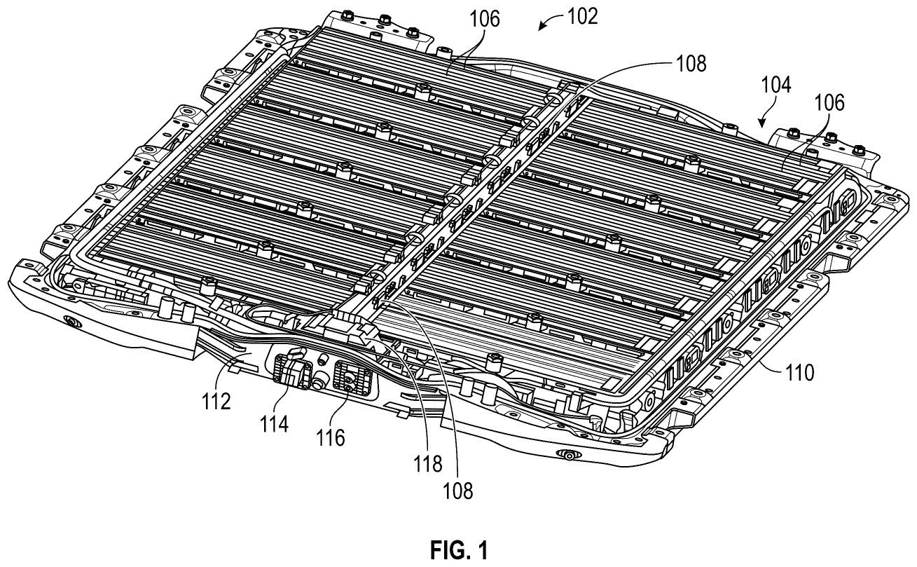

FIG. 1 illustrates a product 102, which may include rechargeable energy storage system 104 and a battery disconnect unit 118. The battery disconnect unit 118 may contain the contactors, fuses, pre-charge circuit and current sensors. The battery disconnect unit 118 may include components for monitoring, activating, and deactivating the high-voltage battery system. The rechargeable energy storage system 104 may include a plurality of battery cells 106 and a plurality of bus bars 108 connecting groups of the plurality of battery cells 106 together in series. The rechargeable energy storage system 104 may be supported by a bottom cover 110 of a battery pack enclosure, which will be described hereafter. An electrical connector support frame 112 may be mounted to the bottom cover 110 may include a first electrical connector 114 and a second electrical connector 116. The battery disconnect unit 118 may be interposed between the rechargeable energy storage system 104 and the first electrical connector 114 and the second electrical connector 116.

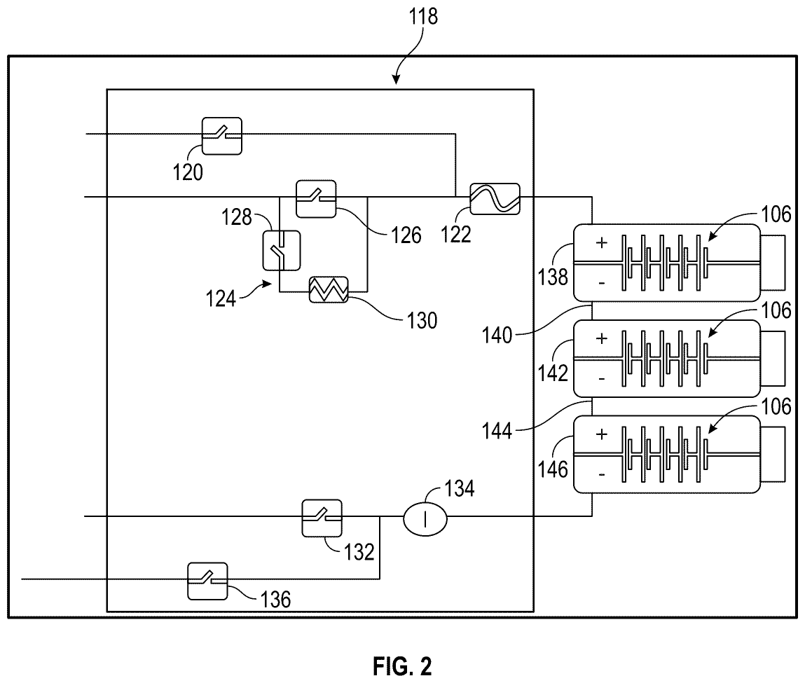

FIG. 2 is a schematic illustration of some of the components that may be included in the battery disconnect unit 118, which may include a direct-current fast charge positive contactor 120 electrically connected to a main fuse 122. Electrical circuit 124 may be provided and may include a main positive contactor 126 electrically connected to a pre-charge contactor 128, which may be electrically connected to a pre-charge resistor 130. The electrical circuit 124 may be electrically connected to the main fuse 122. The battery disconnect unit 118 may also include a main negative contactor 132 electrically connected to a current sensor 134. A direct-current fast charge negative contactor 136 may also be electrically connected to the current sensor 134. The main fuse 122 connected to a positive terminal of a first group 138 of the plurality of battery cells 106. A negative terminal of the first group 138 of the plurality of battery cells 106 may be electrically connected by a first electrical contact 140 to a positive terminal of a second group 142 of the plurality of battery cells 106. A negative terminal of the second group 142 of the plurality of battery cells 106 may be electrically connected by a second electrical contact 144 to a positive terminal of a third group 146 of the plurality of battery cells 106.

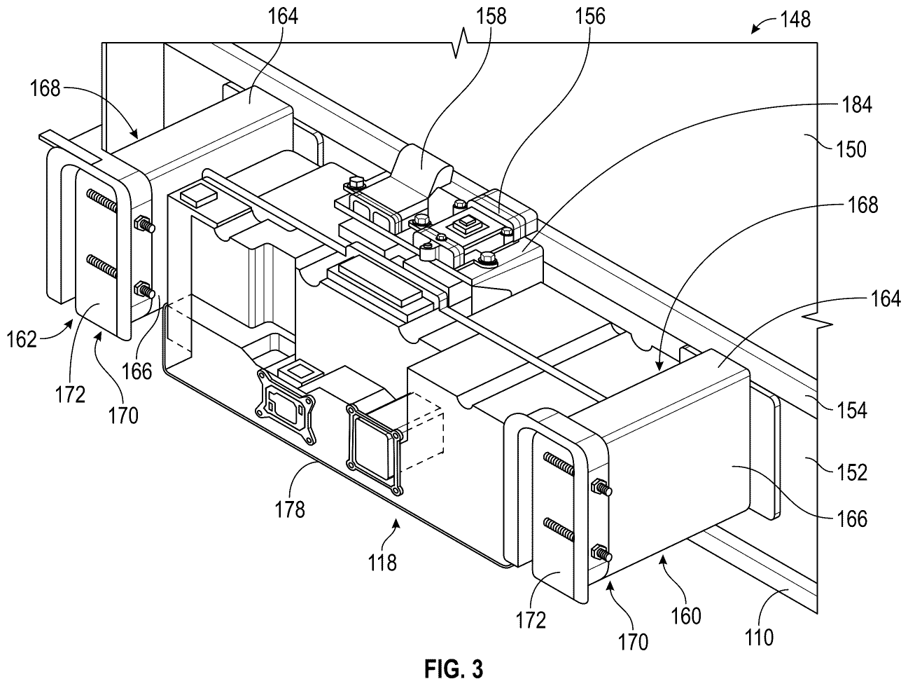

FIG. 3 illustrates a battery pack enclosure 148 which may include an enclosure top cover 150, enclosure front face 152 and a connector mounting plate 154 connected to at least one of the enclosure top cover 150 and the enclosure front face 152. A first high-voltage connector 156 and a second high-voltage connector 158 may be mounted to a mounting platform 184 attached to the enclosure front face 152. A first external bracket 160 and a spaced apart second external bracket 162 may each be attached to the enclosure front face 152. Each of the first external bracket 160 and second external bracket 162 may include a bracket top face 164 connected to a bracket first side face 166 and an opposite spaced apart bracket second side face 168. A bracket bottom face 170 may be connected to the bracket first side face 166 and the opposite spaced apart bracket second side face 168. A bracket front face 172 may be connected to the bracket top face 164, bracket first side face 166, bracket second side face 168 and bracket bottom face 170. The battery disconnect unit 118 may include a bottom support substrate 178 which may be removably attached, connected, or fastened directly to or indirectly to the battery pack enclosure 148. For example, the battery disconnect unit 118 may be connected to the at least one of the bracket bottom face 170, bracket front face 172, bracket first side face 166, bracket second side face 168, bracket top face 164.

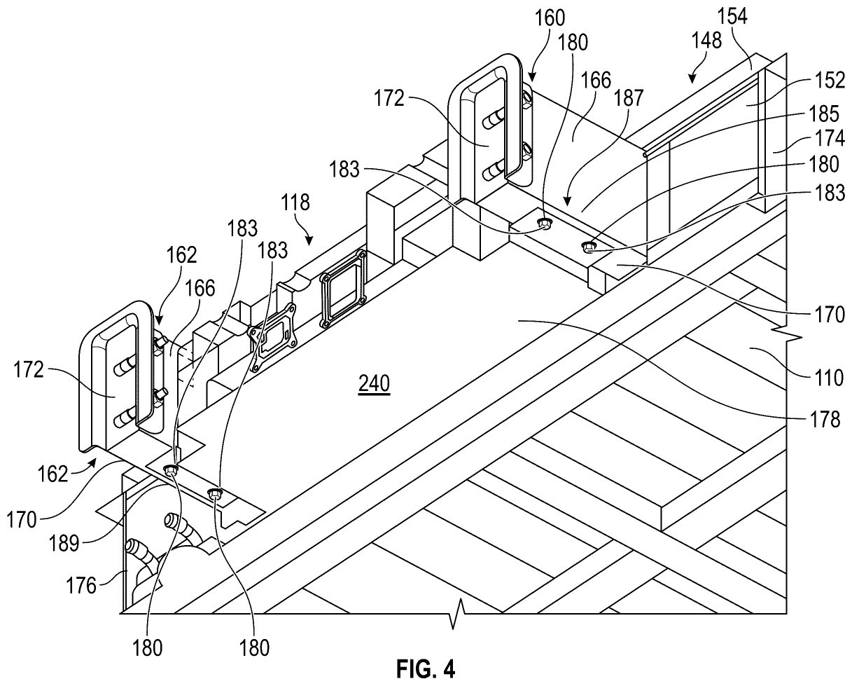

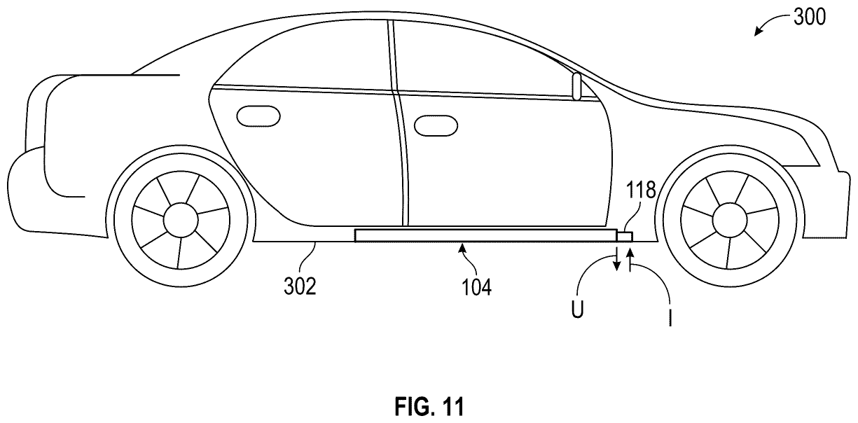

FIG. 4 illustrates the battery disconnect unit 118 wherein the bottom support substrate 178 may include fastening features 183, which may include one or more through holes 183 at a first end 187 of the bottom support substrate 178 or one or more through holes 183 at a second end 189 of the bottom support substrate 178. The bottom support substrate 178 may be attached by fasteners 180, such as but not limited to screws, to the bracket bottom face 170 of the first external bracket 160 and is attached by fasteners 180, such as but not limited to screws, to the bracket bottom face 170 of the second external bracket 162. The battery disconnect unit 118 may be assembled/installed or disassembled/uninstalled from the battery pack enclosure 148 from the bottom of electric vehicle without having to remove the rechargeable energy storage system 104 from the battery pack enclosure 148, as will be described hereafter with reference to FIG. 11.

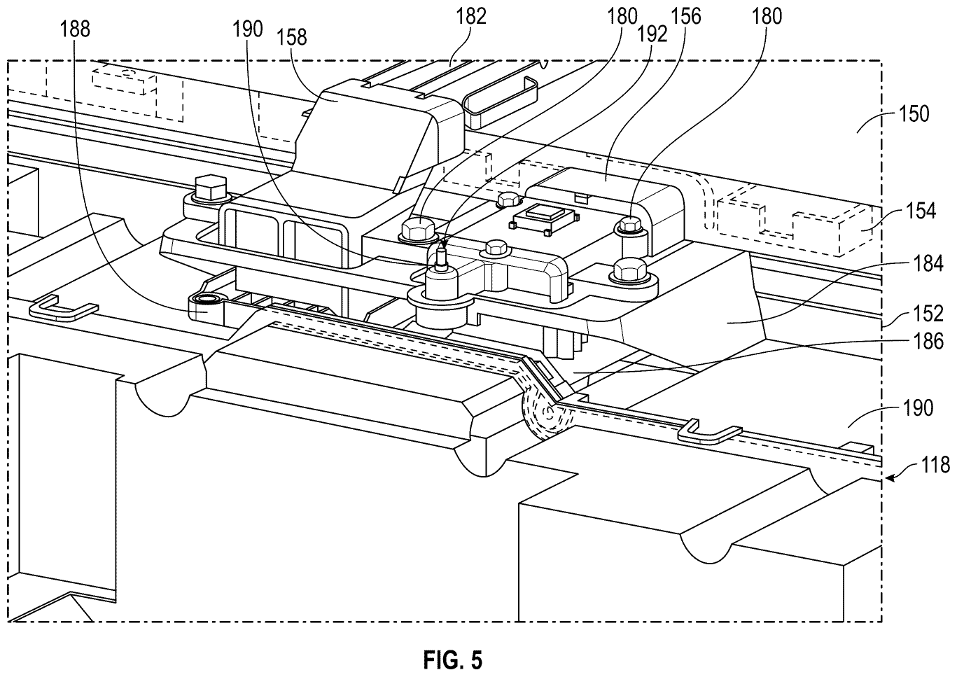

FIG. 5 illustrates a number of variations where in the battery disconnect unit 118 may include third high-voltage connector 186, and optionally a fourth high-voltage connector 188. The first high-voltage connector 156 may include a through hole 190 formed therein. The third high-voltage connector 186 may include a seating verification pin 192 positioned to extend through the through hole 190 in the first high-voltage connector 156 to verify the proper seating of the third high-voltage connector 186 of the battery disconnect unit to the first high-voltage connector 156. The third high-voltage connector 186 and the fourth high-voltage connector 188 may include blade contacts for mating with receiving contacts in the first high-voltage connector 156 and the second high-voltage connector 158, respectively.

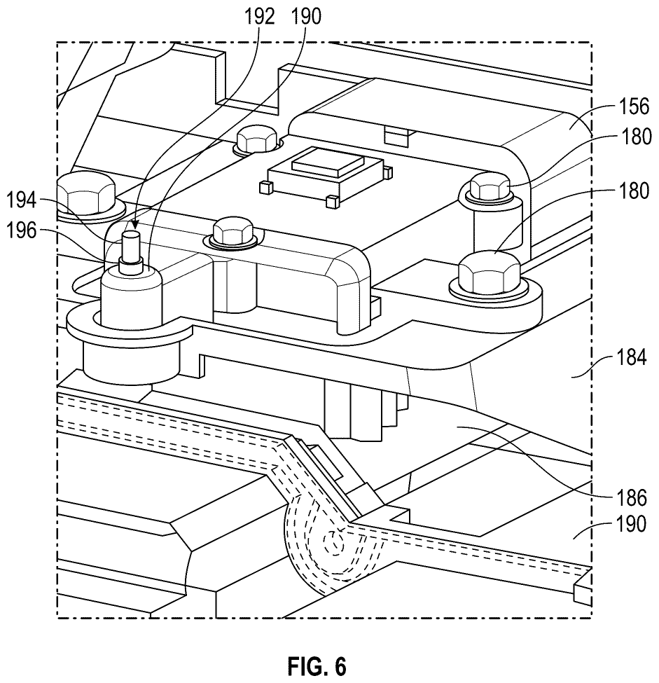

FIGS. 5-6 illustrate a number of variations wherein the seating verification pin 192 includes a first portion 194 at a first end and a second portion 196 adjacent the first portion 194. The first portion 194 may have a first color, for example red, and the second portion 196 may have a second color, for example green, so that when the third high-voltage connector 186 is properly seated to the first high-voltage connector 156 the second portion 196 of the seating verification pin 192 is visible.

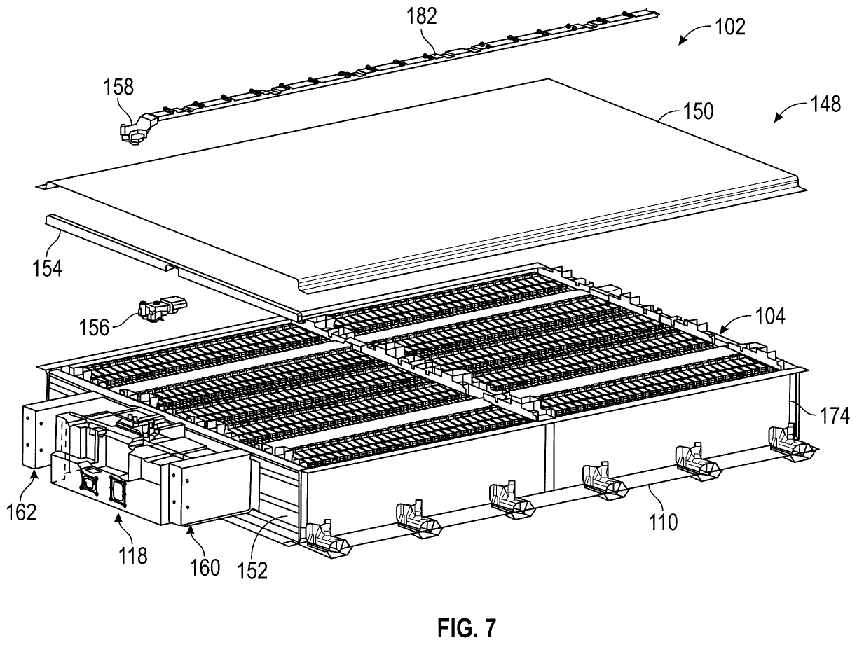

FIG. 7 illustrates a method of assembling a product 102 wherein the battery disconnect unit 118 is installed and attached to the first external bracket 160 and second external bracket 162 with fasteners prior to populating the battery pack enclosure 148 with battery cells and other components.

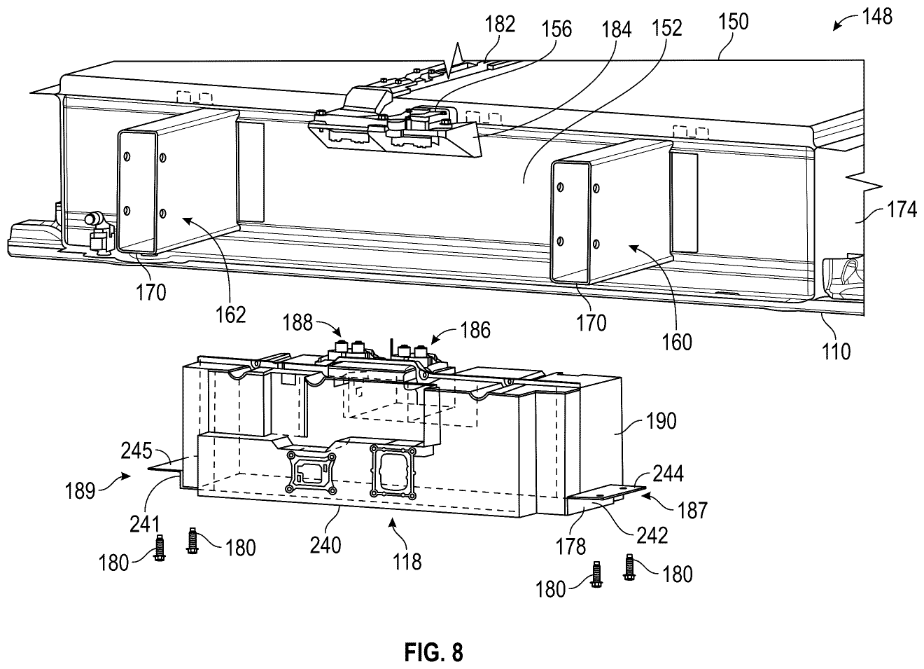

FIG. 8 illustrates a method of servicing the battery disconnect unit 118 by removing fasteners 180 from the first external bracket 160 and the second external bracket 162 so that the battery disconnect unit 118 may be lowered down from the bottom of electric vehicle without having to remove battery cells and other components from the battery pack enclosure 148. As illustrated in FIG. 8, the bottom support substrate 178 may include a central portion 240 which may be planar. At the first end 287 of the bottom support substrate 178, a first side wall 242 may extend upwardly from the central portion 240 and a first flange portion 244 may extend outwardly from the first side wall 242. At the second end 289 of the bottom support substrate 178, a second sidewall 241 may extend upwardly from the central portion 240 and a second flange portion 245 may extend outwardly from the second sidewall 241. The first flange portion 244 may be fastened to the first external bracket 160 and the second flange portion 245 may be fastened to the second external bracket 162.

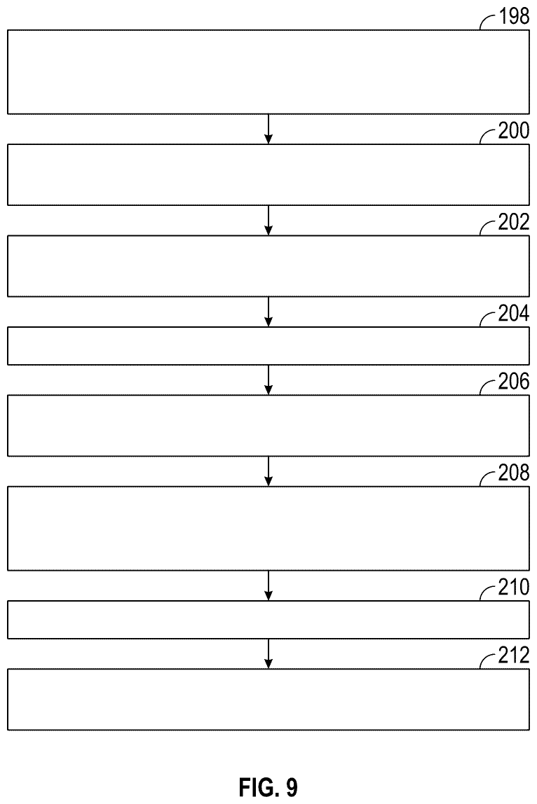

FIG. 9 is a flow chart of a method which may include, starting at block 198, installing the battery disconnect unit to the external brackets of a battery pack enclosure with fasteners prior to populating the battery pack enclosure with battery cells and other components. The method proceeds from block 198 to block 200 which includes installing battery cells in components inside of the battery pack enclosure. The method proceeds from block 200 to block 202 including connecting main pack connector to battery positive and negative of the cells. The method proceeds from block 202 to block 204 including plugging a pack main connector to the battery disconnect unit. The method proceeds from block 204 to block 206 including securing pack main connector to external bracket of pack main enclosure with screws. The method proceeds from block 206 to block 208 including verifying the green portion is visible on the seating verification pin to ensure the connector is fully seated. An electronic vision system may be utilized for this verification. The method may continue from block 208 to block 210 including performing any pack level testing. The method may proceed from block 210 to block 212 including installing and securing the top cover of the battery pack enclosure.

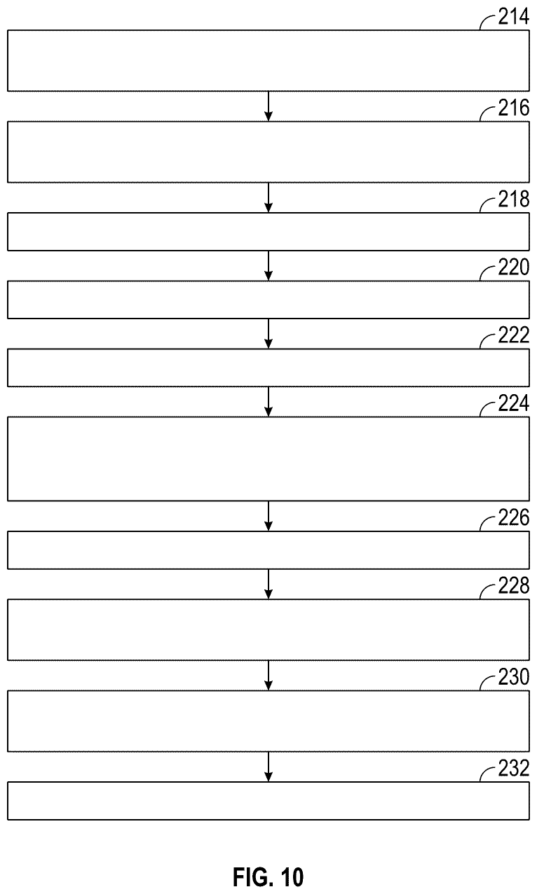

FIG. 10 illustrates a method which may start at block 214 including ensuring that the high-voltage bus is powered down and discharged. The method may proceed from block 224 to block 216 including disconnecting the high-voltage and low-voltage connectors on the battery discharge unit from the high-voltage bus. The method may proceed from block 216 to block 218 including removing any cooling hoses from the battery disconnect unit, if required. The method may proceed from block 218 to block 220 including properly supporting the battery disconnect unit prior to removal. The method may proceed from block 220 to block 222 including removing the bottom attachment screws to disconnect the battery discharge unit from the external brackets. The method may proceed from block 222 to block 224 including lowering the battery discharge unit from the battery pack enclosure, unplugging pack main connector and optional additional connector. The method may proceed from block 224 to block 226 including repairing or replacing the battery discharge unit. The method may proceed from block 226 to block 228 including reinstalling the battery disconnect unit from the bottom of the battery pack enclosure and installing and torquing fasteners to secure the battery discharge unit to the external brackets. The method may proceed from block 228 to block 230 including reconnecting the high and low voltage bus connectors and any cooling hoses, if required. The method may proceed from block 230 to block 232 including verifying that the battery pack battery is performing as designed.

FIG. 11 is a schematic illustration of an electric vehicle 300 having a battery disconnect unit 118 that can be installed and uninstalled from the bottom 302 of the electric vehicle 300 to be connected or unconnected to battery pack enclosure 148. To install, the battery disconnect unit 118 may be moved in the direction of arrow I from underneath the electric vehicle 300 towards the bottom 302 of the electric vehicle 300 and in position to be connected to the battery pack enclosure 148. To uninstall, the battery disconnect unit 118 may be moved in the direction of arrow U away from the bottom 302 of electric vehicle 300.

While at least one variation has been presented in the foregoing detailed description, it should be appreciated that a vast number of variations exist. It should also be appreciated that the variation or variations are only examples, and are not intended to limit the scope, applicability, or configuration of the disclosure in any way. Rather, the foregoing detailed description will provide those skilled in the art with a convenient road map for implementing the illustrative variation or variations. It should be understood that various changes can be made in the function and arrangement of elements without departing from the scope of the disclosure as set forth in the appended claims and the legal equivalents thereof.

What is claimed is:

1. A product, comprising:
a battery disconnect unit comprising a bottom support substrate having at least one fastening feature for removably connecting the battery disconnect unit to at least a portion of a battery pack enclosure, the battery disconnect unit comprising at least one of a contactor, a fuse, or a pre-charge circuit carried on top of the bottom support substrate.

2. The product as set forth in claim 1 further comprising at least a portion of a battery pack enclosure, and wherein the battery disconnect unit is removably connected to the at least a portion of the battery pack enclosure.

3. The product as set forth in claim 2 further comprising at least one external bracket connected to the at least a portion of the battery pack enclosure, and wherein the battery disconnect unit is removably connected to the at least one external bracket.

4. The product as set forth in claim 2 further comprising a first external bracket and a second external bracket each connected to the at least a portion of the battery pack enclosure, wherein the first external bracket and the second external bracket are spaced apart from each other by a distance sufficient to receive at least a portion of the battery disconnect unit therebetween.

5. The product as set forth in claim 4 wherein the bottom support substrate is removably fastened to the first external bracket and the second external bracket.

6. The product as set forth in claim 5 wherein the bottom support substrate includes a central portion and a first end and a second end, and wherein at the first end a first side wall extends upwardly from the central portion and a first flange portion extends outwardly from the first side wall, and wherein at the second end a second side wall extends upwardly from the second end and a second flange portion extends outwardly from the second side wall.

7. The product as set forth in claim 6 further comprising at least one fastener extending through the first flange portion and into the first external bracket, and at least one fastener extending through the second flange portion and into the second external bracket.

8. The product as set forth in claim 1 wherein the battery disconnect unit comprises a battery disconnect unit high-voltage connector comprising a seating verification pin.

9. The product as set forth in claim 8 further comprising a battery pack enclosure, a connector platform, a battery pack high-voltage connector secured to the connector platform, and wherein the battery pack high-voltage connector is connected to the battery disconnect unit high-voltage connector so that the seating verification pin extends through a through hole formed in the battery pack high-voltage connector so that a proper seating indicator is visible on the seating verification pin.

10. A method comprising:
providing an electric vehicle having a battery pack enclosure having therein a rechargeable energy storage system including a plurality of battery cells and a high-voltage bus operatively connected to the plurality of battery cells, a battery disconnect unit removably attached to the battery pack enclosure, the electric vehicle having a bottom, wherein the battery disconnect unit includes at least one battery disconnect unit high-voltage connector connected to the high-voltage bus;
disconnecting the at least one battery disconnect unit high-voltage connector from the high-voltage bus
supporting the battery disconnect unit and thereafter detaching the battery disconnect unit from the battery pack enclosure; and
lowering the battery disconnect unit from the battery pack enclosure so that the battery disconnect unit moves downwardly away from the bottom of the electric vehicle.

11. The method as set forth in claim 10, wherein prior to disconnecting the at least one battery disconnect unit high-voltage connector from the high-voltage bus, de-energizing the battery and high voltage bus.

12. The method as set forth in claim 10 further comprising repairing or replacing the battery disconnect unit.

13. The method as set forth in claim 12 further comprising reinstalling the battery disconnect unit by moving the battery disconnect unit upward towards the bottom of the electric vehicle and removably connecting the battery disconnect unit to the battery pack enclosure.

14. The method as set forth in claim 10 wherein the battery disconnect unit comprising a bottom support substrate having at least one fastening feature for removably connecting the battery disconnect unit to a battery pack enclosure, and at least one of a contactor, a fuse, or a pre-charge circuit carried on top of the bottom support substrate.

15. The method as set forth in claim 14 further comprising a first external bracket and a spaced apart second external bracket both attached to the battery pack enclosure, wherein at least a portion of the battery disconnect unit is received between the first external bracket and the spaced apart second external bracket, and wherein the bottom support substrate is fastened to each of the first external bracket and the spaced apart second external bracket.

16. A method comprising:
providing a battery pack enclosure including at least a bottom cover and a front face connected to the bottom cover;
providing a battery disconnect unit having a battery disconnect unit high-voltage connector having a seating verification pin having a portion of which has a color to indicate that the battery disconnect unit high-voltage connector is properly seated;
connecting the battery disconnect unit to the front face of the battery pack enclosure;
installing battery cells inside the battery pack enclosure;
connecting a battery pack high-voltage connector to a battery positive terminal and a negative terminal, the battery pack high-voltage connector having a through hole formed therein for receiving the seating verification pin; and
connecting the battery pack high-voltage connector to the battery disconnect unit high-voltage connector so that the seating verification pin extends through the through hole formed in the battery pack high-voltage connector so that the color to indicate that the battery disconnect unit high-voltage connector is properly seated is visible.

17. The method as set forth in claim 16 further comprising performing pack level testing.

18. The method as set forth in claim 16 wherein the battery pack enclosure further comprises:
a first side face connected to the front face;
an opposite second side face each connected to the front face;
a rear face connected to the first side face, the rear face connected to a second side face, and wherein the method further comprises attaching a top cover to the first side face, second side face, rear face and front face to close the battery pack enclosure.

19. The method as set forth in claim 16 further comprising:
a first external bracket attached to the front face; and
a spaced apart second external bracket attached to the front face, wherein the battery disconnect unit includes a bottom support substrate, and wherein the connecting the battery disconnect unit to the front face of the battery pack enclosure comprises connecting the bottom support substrate to the first external bracket and to the spaced apart second external bracket so that the battery disconnect unit is received between the first external bracket and the spaced apart second external bracket.

20. The method as set forth in claim 19 wherein each of the first external bracket and the spaced apart second external bracket includes a bottom face, and wherein connecting the bottom support substrate to the first external bracket and to the spaced apart second external bracket comprises connecting the bottom support substrate to the bottom face of the first external bracket and the bottom face of the spaced apart second external bracket.
